(19) United States
(12) Patent Application Publication
(10) Pub. No.: US 2004/0190756 A1
(43) Pub. Date: Sep. 30, 2004

(54) Biometric enabled mailbox system

(76) Inventors: James Kim, Bayside, NY (US); Denis Khoo, Arcadia, CA (US)

Correspondence Address: DENIS KHOO, 9729 CAMINO REAL, ARCADIA, CA, 91007, US

(21) Appl. No.: 10/397,935

(22) Filed: Mar. 25, 2003

(51) Int. Cl. G06K 9/00

(52) U.S. Cl. 382/115

(57) ABSTRACT

A system is described for providing a biometric enabled mailbox. The biometric enabled mailbox system is comprised of a biometric sensor for unlocking the mailbox. This biometric sensor is also used for programming the biometric enabled mailbox system, along with a storage medium for storing authorized biometric identifiers, a programming interface for programming a mailbox, processor for performing validation, and a powered lock for unlocking a mailbox upon validation of an inputted biometric identifier. The system can be adapted to a single mailbox environment as well as a multiple mailbox environment.

### BACKGROUND OF THE INVENTION

1. Field of the Invention

The present invention relates generally to mailboxes, and more particularly, to a new mailbox system that operates via biometric means.

2. Description of the Related Art

Mailboxes have remained relatively simple throughout the ages. Very little, if any, advancements in technology have influenced the mailbox. The typical mailbox 100 is a rectangular type container with a hinged panel 110 either on top or on one of its sides. A mail delivery person will open the hinged panel 110 and insert new mail into the mailbox 100 during delivery. Thereafter, the owner of the mailbox 100 will retrieve his/her mail by using the same hinged panel 110 to get inside the mailbox to retrieve his/her mail.

Many newer mailboxes offer locking capabilities. Just about every mailbox in an apartment and office complex offers locking capabilities. Most multiple residence properties, such as high rise condominiums, also offer locking mailboxes. Mailboxes within an apartment or office complex are typically grouped in one centralized location for all of the building's tenants. Without locking capabilities, it would be too easy for a mail thief to steal mail from multiple mailboxes.

FIG. 2 is an example of a mailbox in a four unit apartment complex. As shown in FIG. 2, there are four individual mailboxes, and each has a label 220 to identify which apartment unit the mailbox belongs to. The mail delivery person is able to access all four mailboxes via the master key socket 230. The mail delivery person is given a key for this master key socket 230 in advance. After using the given key on the master key socket 230, the mail delivery person can then access and insert mail for all four of the individual mailboxes. A person dwelling in the apartment complex can open his/her individual mailbox using the individual mailbox key socket 210 with a key which has been assigned to that individual. The individual mailbox key socket 210 is used to unlock the individual mailbox and also to lock the individual mailbox.

Unlike with mailboxes within apartment and office complexes, many residential mailboxes today do not have locking capabilities. FIG. 1 is an example of a typical residential mailbox. As shown, this typical residential mailbox 100 offers a hinged panel 110 which swings open, and allows access into the mailbox. The mail delivery person inserts new mail into the mailbox 100 by opening the hinged panel 110, inserting the new mail, and closing the hinged panel 110. Similarly, the mailbox owner retrieves new mail from this mailbox 100 by using the same hinged panel 110. Because this mailbox 100 offers no locking capabilities, anyone can access the contents of the mailbox 100. However, due to the recent rise in identity thief, more and more residential mailboxes are being upgraded by homeowners to offer locking capabilities.

The mail delivery person can deliver new mail into these locking mailboxes by one of two means. One means is by providing the mail delivery person with a key that unlocks the mailbox. An example of this is the mailbox from FIG. 2. As mentioned earlier, the mail delivery person accesses the mailbox 200 via the master key socket 230.

The other means is by providing a slot within which the mail delivery person can insert the new mail without having to unlock the mailbox. Once the mail is delivered into the slot, it drops down onto the bottom of the mailbox. Thereafter, the new mail should not be removable using the slot. The owner of the mail can unlock a panel of the mailbox using a key, and thus retrieve the newly arrived mail. There are also some mailboxes that provide a combination lock as an alternative to a key for unlocking the mailbox.

As people's privacy becomes more of a concern, and identity thief skyrockets, it is much more common to find mailboxes with locking capabilities. Unfortunately, with locking mailboxes, a new burden has been added for individuals to obtain a key every time they need to check for new mail or retrieve their mail. With mailboxes which have combination locks, there is the burden of having to memorize the combination, as well as enter the combination each time the individual needs to unlock his/her mailbox. And since mail arrives nearly everyday, the burden is frequent. In addition, locking mailboxes which use a key typically require that the same key be used to lock the mailbox. There is also the disadvantage of having to carry the mail key and the possibility of misplacing the mail key.

There needs to be a way to provide highly secure mailboxes without the burden of today's unlocking schemes.

### SUMMARY OF THE INVENTION

The present invention is a system for a secure and advanced biometric enabled mailbox. Unlike current mailboxes which require the conventional key for locking and unlocking, the mailbox of this invention does not require a key for unlocking and locking. The mailbox of this invention is unlocked via biometric means. Some examples of biometric means include fingerprint scanning, voice recognition, DNA sampling, and retinal scanning. To unlock this biometric enabled mailbox, a mailbox user need not carry any device, nor memorize any combinations. To unlock this biometric enabled mailbox, the mailbox user need only be present to provide some form of biometric identity, also known as biometric identifier. Examples of biometric identifiers include the mailbox user's finger/fingerprint, the mailbox user's retinal, and the mailbox user's voice.

Each biometric enabled mailbox system of this invention is associated with one or more mailbox users. Accordingly, the mailbox is programmed so that it can be unlocked only by its mailbox user(s). The mailbox can be reprogrammed to recognize new mailbox user(s) and delete old mailbox user(s), thus granting access to the new mailbox user(s) and denying access to the old mailbox user(s).

When an authorized mailbox user provides a biometric identifier to the biometric enabled mailbox, the biometric enabled mailbox will automatically unlock via a powered unlocking mechanism after a biometric authentication has been performed. This provides the mailbox user with instant and easy access to the contents within the biometric enabled mailbox.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a prior art diagram of a residential mailbox.

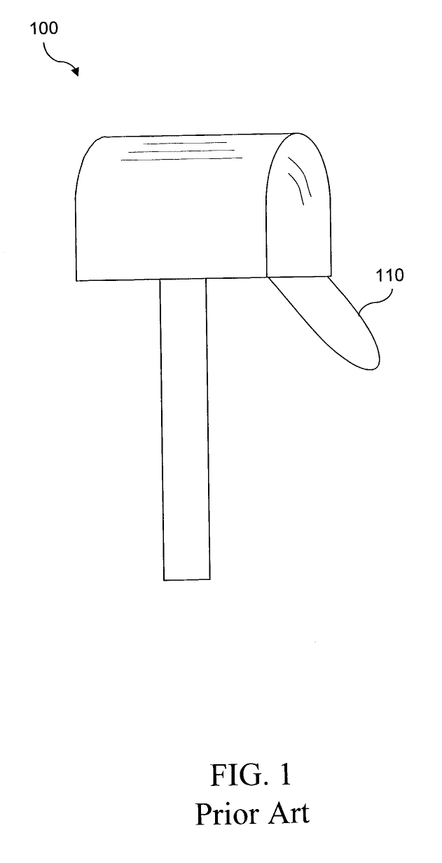

FIG. 2 is a prior art diagram of a multiple residence mailbox.

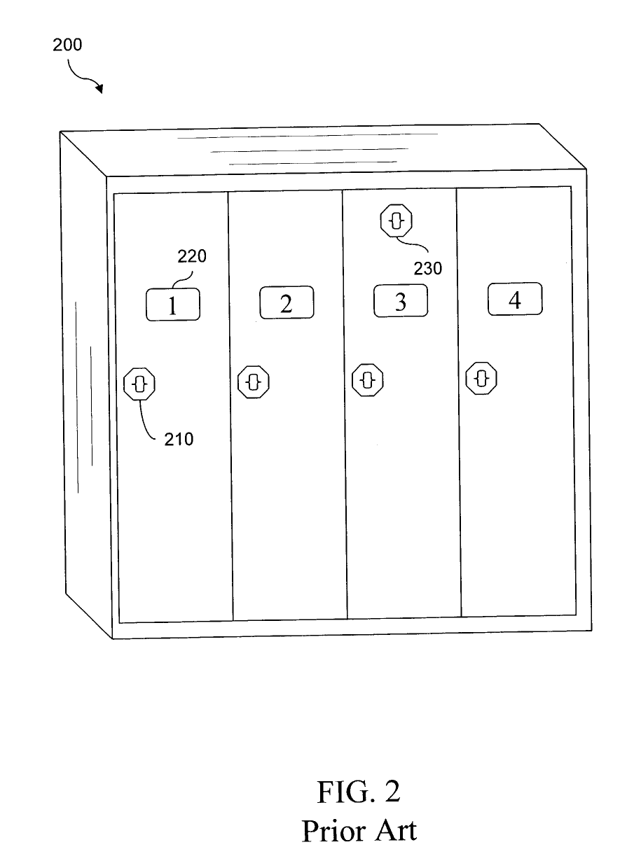

FIG. 3 is a technical block diagram of an embodiment of the system of the present invention.

FIG. 4 is a flowchart diagram for using an embodiment of a biometric enabled mailbox system.

FIG. 5 is a flowchart diagram for administering an embodiment of a biometric enabled mailbox system.

FIG. 6A is a front perspective view of an embodiment of a biometric enabled residential mailbox.

FIG. 6B is a back perspective view of an embodiment of a biometric enabled residential mailbox.

FIG. 7A is a back perspective view of an embodiment of a biometric enabled residential mailbox.

FIG. 7B is a back perspective view of an embodiment of a biometric enabled residential mailbox with the lockable panel opened.

FIG. 8 is a front perspective view of an embodiment of a biometric enabled apartment mailbox.

FIG. 9 is a technical block diagram of an embodiment of the system of the present invention.

### DETAILED DESCRIPTION OF THE PREFERRED EMBODIMENTS

System Overview

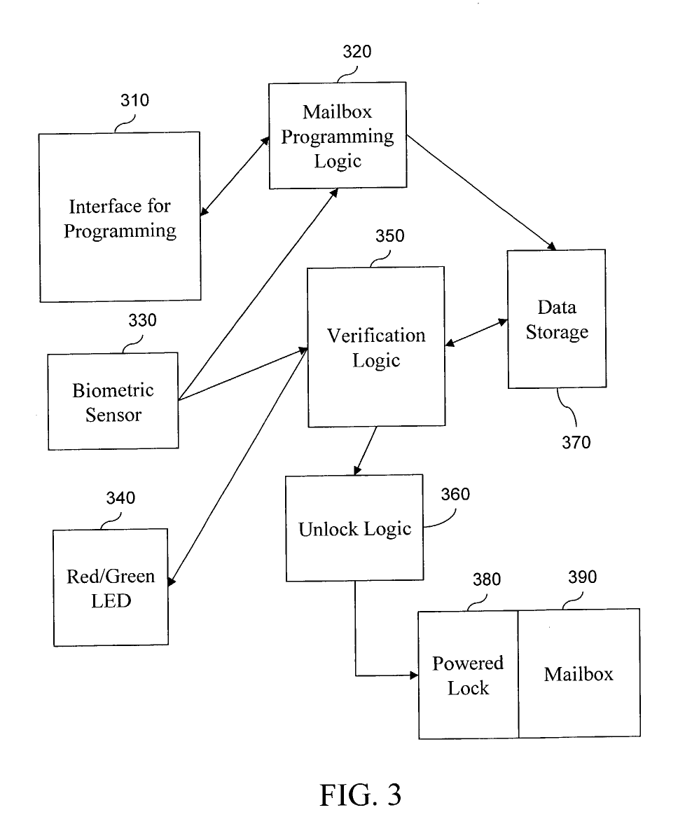

FIG. 3 is a technical block diagram view of an embodiment of a biometric enabled mailbox system. This embodiment shows the components for a typical system used to operate a single mailbox via biometric means.

A mailbox user interacts with a biometric sensor 330. The biometric sensor will vary depending on the specific biometric means implemented. Some examples of biometric sensors 330 include a fingerprint scanner, retinal scanner, or a voice sensor. The mailbox user supplies the biometric sensor 330 with the proper biometric identifier. For example, if the biometric sensor 330 is a fingerprint scanner, the mailbox user interacts with the system by supplying the biometric sensor 330 with his/her finger for fingerprint scanning. In this case, the biometric identifier is the specific mailbox user's finger/fingerprint. The biometric sensor 330, after scanning the fingerprint, converts the scanned fingerprint into a data equivalent format. This data equivalent format of the scanned fingerprint contains enough information necessary to compare two different scanned fingerprints against one another.

A mailbox user is notified of the biometric enabled mailbox system's status via a couple of LED lights 340. One of the LED's color is red, and the other LED's color is green. The red LED would flash to indicate to the mailbox user that the unlocking process has failed, while the green LED would flash to indicate to the mailbox user that the unlocking process has completed successfully.

The biometric enabled mailbox system also contains an interface 310 used for programming and customizing the system. Naturally, each biometric enabled mailbox system needs to know which biometric identifiers are allowed to unlock the mailbox. Biometric identifiers which are allowed to unlock the mailbox are described as authorized biometric identifiers. The biometric enabled mailbox system needs to be programmed in order for it to know which biometric identifiers are valid. The interface for programming 310 allows for a mailbox administrator to program the biometric enabled mailbox system. A mailbox administrator is a person who is authorized to program the biometric enabled mailbox system. Some possible interfaces for programming 310 include a computer system electronically networked or connected to the biometric enabled mailbox system, a keypad and display connected to the biometric enabled mailbox system, a touch screen display connected to the biometric enabled mailbox system, or a customized set of push buttons connected to the biometric enabled mailbox system. The interface for programming 310 provides enough of an interface to allow a mailbox administrator to add and remove biometric identifiers from the biometric enabled mailbox system.

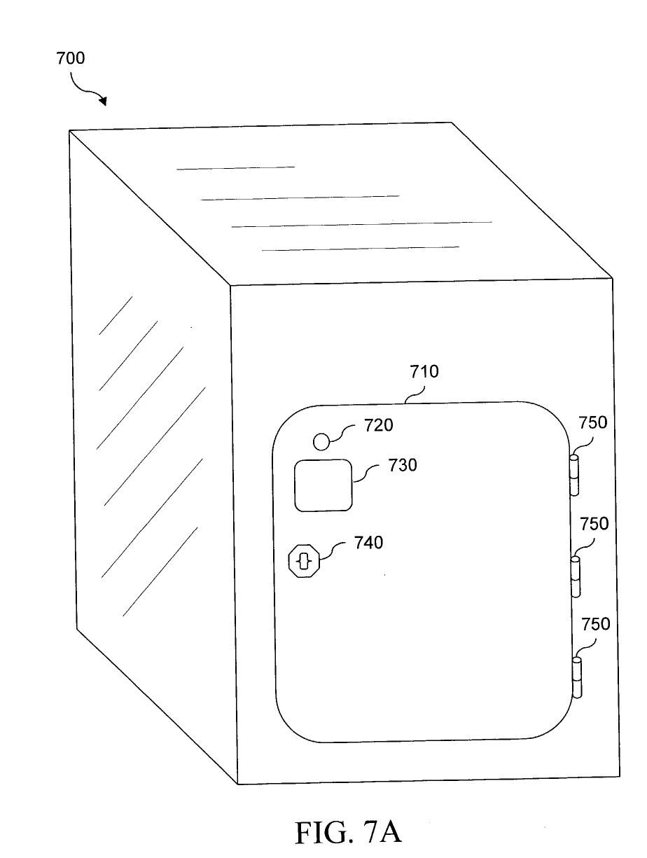

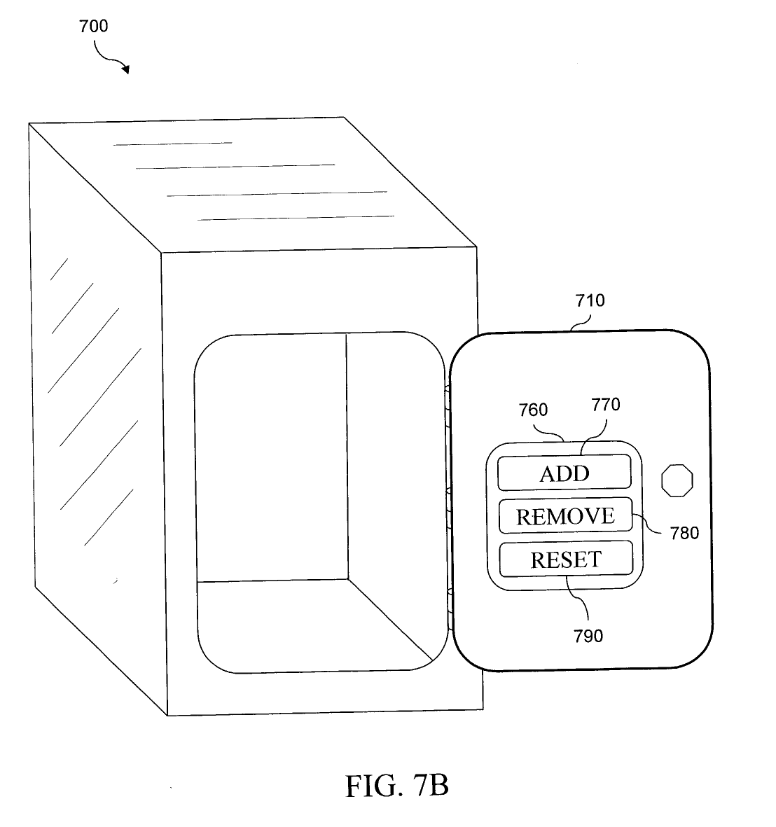

The interface for programming 310 is safeguarded as to allow only the mailbox administrator to program the biometric enabled mailbox system. This can be accomplished in a variety of fashions. One method would be by keeping the interface for programming 310 inactive unless properly activated. Some forms of activation include punching in a security code on a keypad, using a customary key and keyhole for activation purposes, or providing a biometric identifier by the mailbox administrator via the biometric sensor 330. Another method of safeguarding would be to physically hide the interface for programming 310, as shown in FIG. 7b.

The interface for programming 310 is connected to the mailbox programming logic 320. The mailbox programming logic 320 is responsible for accepting input from the interface for programming 310 and performing the appropriate action. The mailbox programming logic 320 has access to the data storage 370 of the biometric enabled mailbox system, and has the ability to add and remove biometric identifiers from this data storage 370. Additional information, such as an association between a mailbox number and a particular biometric identifier, can also be stored in this data storage 370 by the mailbox programming logic 320.

The data storage 370 component of the biometric enabled mailbox system is responsible for storing data information. Some examples of data information required for storage by the biometric enabled mailbox system include authorized biometric identifiers, associations between a biometric identifier and a particular mailbox, a mailbox administrator's biometric identifier, and a log of all mailbox system activities. A log of mailbox system activities can include the time and date the mailbox system was successfully unlocked, the biometric identifier that successfully unlocked the mailbox, time and date the mailbox system was unsuccessfully unlock, the biometric identifier that unsuccessfully unlocked the mailbox, time and date an authorized biometric identifier was added, and other such activities. Some possible data storage means 370 include flash memory, a floppy disk, a hard disk, or RAM.

In addition to the mailbox programming logic 320, there is also the verification logic 350 and unlock logic 360. All of these logic components can individually be coded in the form of software or hardware. If the logic component is in the form of hardware, it can be an embedded logic component.

The verification logic 350 is responsible for accepting an input from the biometric sensor 330 and verifying that the inputted biometric identifier matches an authorized biometric identifier. The verification logic 350 performs this task by accessing the set of authorized biometric identifiers from the data storage 370. If there are multiple mailboxes involved, the verification logic 350 is also responsible for figuring out which mailbox the biometric identifier is valid for. This information is necessary to determine which mailbox to unlock in a multiple mailbox setup. The verification logic 350 also sends a signal to the LED 340 to tell it to flash either a red light or a green light. The verification logic 350, upon successfully performing a validation will send a signal or message to the unlock logic 360.

In a single mailbox environment, the unlock logic 360 is unnecessary, as it is trivial to unlock a single mailbox, which involves sending a power current to the powered lock 380 to unlock the mailbox 390. This simple task can be handled directly by the verification logic 350. However, in a multiple mailbox environment, the unlock logic 360 needs to determine which power lock 380 to unlock from multiple power locks 380.

The unlock logic 360 sends a power current to the powered lock 380 which unlocks the mailbox 390. Several types of power locks 380 are already in existence today. Some examples include electromagnetic locks, actuator activated powered locks, and electric strike.

Electric strike requires power to either keep the lock locked or unlocked. If it requires power to keep the lock locked, the lock is known as a fail safe lock. Thus with a fail safe lock, when there is no power, the lock automatically unlocks. A fail safe lock requires power to hold the lock in the locked position. A fail secure lock stays locked even without power. A fail secure lock requires power to hold the lock in the unlocked position.

An electromagnetic lock is always a fail safe lock. When there is no power, the lock will be unlocked. Electromagnetic locks work by using powered magnetic force to keep a door locked.

An actuator activated power lock is often found in vehicles. The actuator operates via a motor and gears to physically switch a door into the locked position and also to physically switch a door into the unlocked position. With an actuator activated power lock, the lock remains in whichever position (locked or unlocked) even without power. An actuator activated power lock requires power to change from an unlocked state to a locked state and vice versa.

Once the mailbox 390 is unlocked, the mailbox user can access the contents of the mailbox.

Methodology

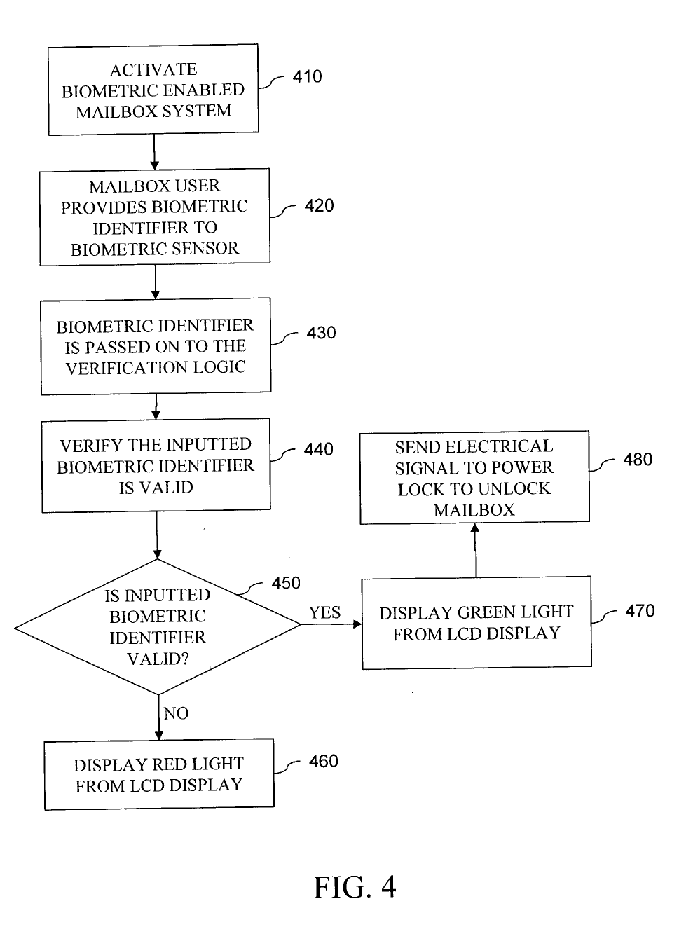

FIG. 4 is a flowchart of an embodiment of the usage of the biometric enabled mailbox system.

In the first step 410, the biometric enabled mailbox system can be activated by automatically sensing that a biometric identifier has been supplied. For example, if the biometric sensor 330 is a fingerprint scanner 330, the biometric enabled mailbox system would automatically be activated once a finger is placed on the fingerprint scanner 330. In this case, since the biometric enabled mailbox system is automatically activated by having a finger placed on the fingerprint scanner 330, the system immediately jumps to the next step 420, and begins scanning the fingerprint and continuing with the unlocking process.

It is also possible for the biometric enabled mailbox system to be activated via an activation switch. The disadvantage of this is that it requires additional parts, circuitry, and another step for the mailbox user. The advantage is that the biometric enabled mailbox system will only attempt to process a biometric identifier when the activation switch has been activated.

Once activated the biometric enabled mailbox system will process to the next step 420, where the biometric enabled mailbox system will receive the biometric identifier via the biometric sensor 330. The received biometric identifier is then sent to the verification logic 350 in step 430. The verification logic 350 then performs step 440. The verification logic 350 is an embedded logic component whose job is to check the inputted biometric identifier against a set of stored and authorized biometric identifiers. These stored and authorized biometric identifiers are saved into the system in advance via the administrative functionality of the biometric enabled mailbox system, which will be further discussed later.

The verification logic 350 accesses the data storage 370 to retrieve the set of stored and authorized biometric identifiers. Depending on the biometric enabled mailbox system's usage, the data storage 370 may contain multiple authorized biometric identifiers, one authorized biometric identifier, or no authorized biometric identifier.

In step 450, if the verification logic 350 fails to match the inputted biometric identity against any of the stored and authorized biometric identifiers, then the verification will fail, and the mailbox 390 will not be unlocked. Optionally, there may be a visible LED display 340 for the mailbox user. This LED display 340 will display a red light in step 460 to notify the mailbox user that the verification process has failed, and that the mailbox 390 will not be unlocked.

In step 450, the verification logic 350 will successfully verify the inputted biometric identifier if it matches at least one of the stored and authorized biometric identifiers. If the verification is completed successfully, the optional LED display 340 will display a green light in step 470 to notify the mailbox user that the verification process has succeeded and that mailbox 390 will be unlocked. The verification logic 350 now sends a signal or message to the unlock logic 360. For a single mailbox environment, only a simple single is sent. In a multiple mailbox environment, a message containing information about which mailbox to unlock would be sent as opposed to a simple signal. In this final step 480, the unlock logic 360, upon receiving a signal from the verification logic 350, merely has to unlock the powered lock 380. This is performed by sending an electrical signal from the unlock logic 360 to the powered lock 380. The mailbox 390 is now unlocked, and the mailbox user is able to access the inside of the mailbox 390.

As described, the mailbox user is able to easily access the mailbox 390 simply by activating the biometric enabled mailbox system and providing it with a biometric identifier. From the mailbox user's perspective, the process is simple, quick and efficient.

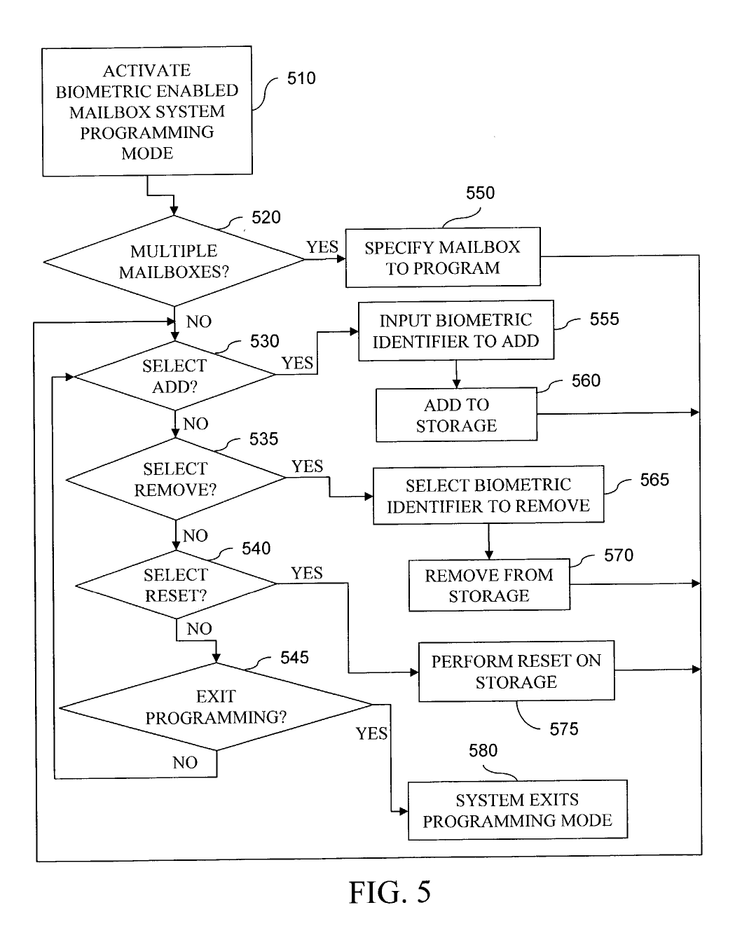

FIG. 5 is a flowchart of an embodiment of the programming of the biometric enabled mailbox system.

In the first step 510, the programming mode needs to be activated. As mentioned previous, the biometric enabled mailbox system is safeguarded so that only the mailbox administrator(s) can program the system. Several means of safeguarding the biometric enabled mailbox system from being programmed by unauthorized individuals have been discussed previously.

Once past the safeguard, the biometric enabled mailbox system enters the programming mode. While in the programming mode, the mailbox administrator is able to add, remove, and reset the biometric identifiers stored within the system.

After the activation step 510, the next step 520 is where the biometric enabled mailbox system determines if the system is managing multiple mailboxes or just one mailbox. If the system is managing multiple mailboxes, then the system will require the mailbox administrator to specify which mailbox is to be programmed in step 550 before proceeding to step 530. If the system is only managing a single mailbox, it continues directly to step 530.

At step 530, the mailbox administrator can select to perform an addition of authorized biometric identifiers to the system. At step 535, the mailbox administrator can select to perform a removal of an already stored biometric identifier in the system. At step 540, the mailbox administrator can reset all the stored biometric identifiers for a particular mailbox in the system. The option to add, remove, or reset is available until the system exits programming mode in step 580.

If the mailbox administrator decides to add an authorized biometric identifier into the system at step 530, the system will proceed to step 555 where the new biometric identifier to be added is received by the system. For example, if the biometric means is fingerprinting, the system will require that the finger, belonging to the mailbox user to be added, be placed on the fingerprint scanner. The fingerprint scanner will scan the new mailbox user's fingerprint and this new biometric identifier will get stored into the system's data storage 370 as shown in step 560. The mailbox user's whose fingerprint was just added to the system's data storage 370 will now be able to unlock the mailbox.

The mailbox administrator can also decide to remove an authorized biometric identifier already stored in the system in step 535. If the mailbox administrator chooses to do so, the system will proceed to step 565, where the system will require that the mailbox administrator specify which biometric identifier to remove. Once specified, that biometric identifier will be removed from the system's storage, thus no longer granting the mailbox user of that biometric identifier from unlocking the mailbox.

Finally, the mailbox administrator can choose to reset the authorized biometric identifiers for a particular mailbox at step 540. If the mailbox administrator chooses to do this, all of the authorized biometric identifiers stored for that particular mailbox will be removed from the data storage 370 at step 575. As a result, no mailbox user will be able to unlock the particular mailbox unless the mailbox administrator adds a new biometric identifier as in step 530.

When the mailbox administrator is done programming the biometric enabled mailbox system, the programming mode can be exited at step 545. Upon choosing to exit programming mode, the biometric enabled mailbox system will exit programming mode at step 580.

Comprehensive Example

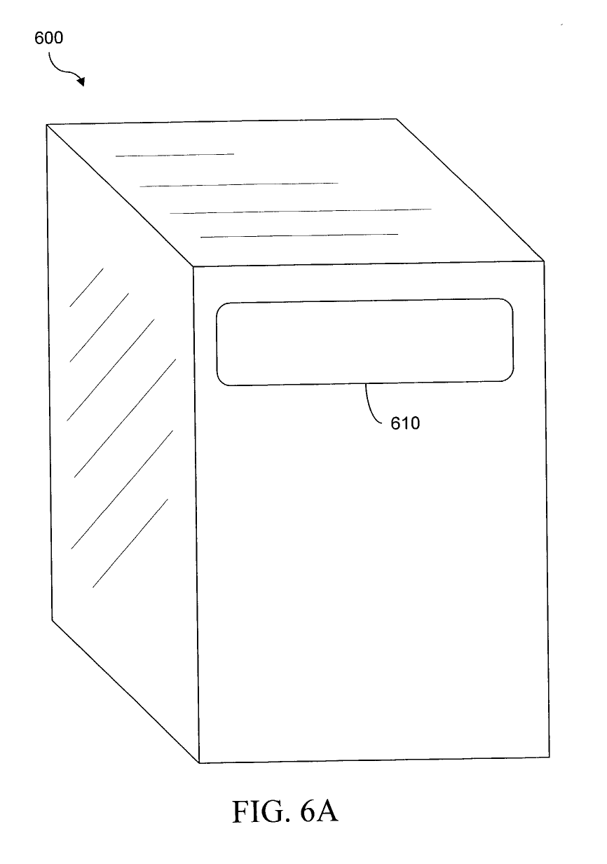

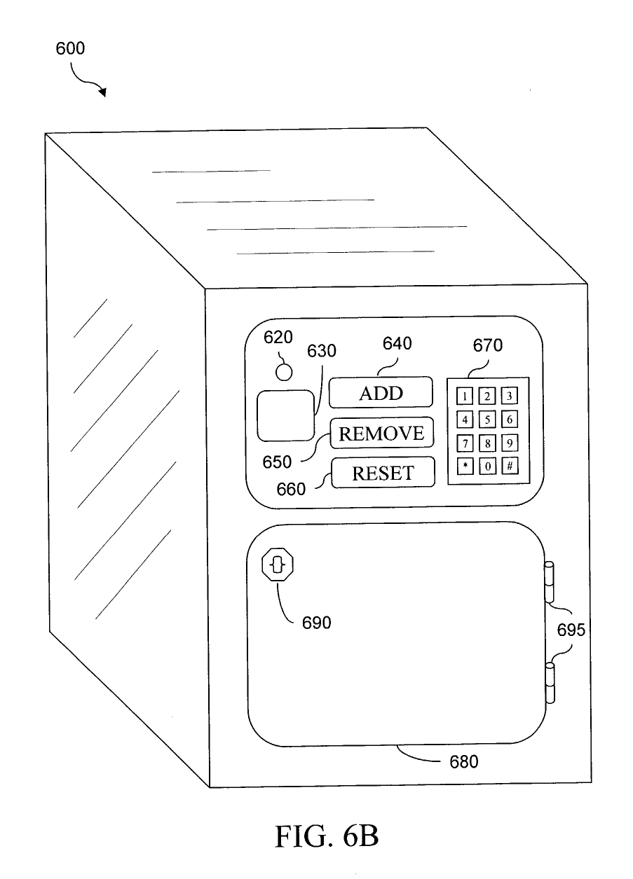

FIG. 6A is a front perspective view diagram of an embodiment of a biometric enabled mailbox system for a single mailbox 600. FIG. 6B is a back perspective view diagram of an embodiment of a biometric enabled mailbox system for the same single mailbox 600.

This mailbox 600 has a slot 610 in the front which is used by the mail delivery person for inserting new mail into the mailbox 600. Once the new mail is inserted into the slot 610, the mail falls to the bottom of the mailbox 600. By having the mail fall to the bottom of the mailbox 600, the mail cannot be removed from the mailbox 600 using the same slot 610. The mail can be removed from the mailbox 600 only by opening the panel 680 at the rear of the mailbox 600.

FIG. 6B shows that at the rear of the mailbox 600, there is an interface for programming (which includes the ADD button 640, the REMOVE button 650, the RESET button 660, and the keypad 670), LED 620, biometric sensor 630 and a hinged panel 680. In this embodiment, the biometric sensor 630 is a fingerprint scanner 630. Also in this embodiment of the mailbox 600, the hinged panel 680 can be unlocked and opened using a key and the key socket 690 or the biometric sensor 630. The hinged panel 680, once unlocked, swings open via the two hinges 695.

A mailbox user places his/her finger on the biometric sensor 630 to activate the biometric enabled mailbox system. The biometric enabled mailbox system will scan the mailbox user's fingerprint and go through a verification process to confirm that the inputted fingerprint is authorized to unlock the mailbox 600. If the biometric enabled mailbox system cannot verify that the inputted fingerprint is authorized to unlock the mailbox 600, then the LED 620 will display a red light to signify a denial in the unlocking process. If the biometric enabled mailbox system verifies that the inputted fingerprint is authorized to unlock the mailbox 600, the LED 620 will display a green light, and the mailbox 600 will unlock. The mailbox user will be able to swing the hinged panel 680 open and access the mail within the mailbox 600.

A mailbox administrator can place this mailbox 600 into programming mode by punching in a secret code using the keypad 670. Once in programming mode, the mailbox administrator is able to add, remove, and reset the biometric identifiers within the mailbox 600.

To add a new mailbox user to the biometric enabled mailbox system, a mailbox administrator will first punch in a secret code using the keypad 670 to place the system into programming mode. The mailbox administrator then presses the button labeled ADD 640. The next step requires that the new biometric identifier be provided to the biometric sensor 630. In other words, the new mailbox user to be added needs to place his/her finger on the fingerprint scanner 630. The biometric enabled mailbox system will scan the fingerprint and store this new biometric identifier into the data storage 370. The LED 620 will display a green light to signify that the add process has completed successfully. This completes the process of adding a new mailbox user to the biometric enabled mailbox system. In this embodiment, the mailbox 600 will exit programming mode automatically after the addition has been completed.

To remove an existing mailbox user from the biometric enabled mailbox system, a mailbox administrator will first punch in a secret code using the keypad 670 to place the system into programming mode. The mailbox administrator then presses the button labeled REMOVE 650. The next step requires that the biometric identifier to be removed be provided via the biometric sensor 630. In other words, the mailbox user's unlocking privileges are to be removed needs to place his/her finger on the fingerprint scanner 630. The biometric enabled mailbox system will scan the fingerprint and find a matching biometric identifier in the data storage 370. If it finds a matching biometric identifier in the data storage 370, it will remove that biometric identifier from the data storage 370 and trigger the LED 620 to display a green light. If it does not find a matching biometric identifier in the data storage 370, the data storage 370 will not be affected and the LED 620 will display a red light. In this embodiment, the mailbox 600 will exit programming mode automatically after the remove has been completed, whether successful or not.

To reset the biometric enabled mailbox system, and thus remove all stored biometric identifiers from the data storage 370, a mailbox administrator will first punch in a secret code using the keypad 670 to place the system into programming mode. The mailbox administrator then presses the button labeled RESET 660 and must hold down this button for over ten seconds. Thereafter, the reset process will continue by removing all biometric identifiers from the data storage 370. The LED 620 will display a green light to notify the mailbox administrator that the reset process has completed successfully. In this embodiment, the mailbox 600 will exit programming mode automatically after the reset process has been completed.

FIG. 7A and FIG. 7B both show a rear perspective view of another embodiment of a biometric enabled mailbox system for a single mailbox. FIG. 7A shows the mailbox 700 with the lockable hinged panel 710 closed, while FIG. 7B shows the mailbox 700 with the lockable hinged panel 710 opened.

With the lockable hinged panel 710 closed, the mailbox 700 does not expose any of its interface for programming (which includes the ADD button 770, REMOVE button 780, and RESET button 790). By doing so, this safeguards the biometric enabled mailbox system from being maliciously programmed by unauthorized individuals. The mailbox 700 can only be programmed when the lockable hinged panel 710 is open. Thus, the mailbox 700 can only be programmed by someone who is authorized to unlock the mailbox.

The mailbox 700 can be unlocked using a conventional key and key socket 740, or via biometric means. The mailbox 700 has a biometric sensor 730 located on the outside of the lockable hinged panel 710. The biometric enabled mailbox system of this embodiment uses a fingerprint scanner 730 as its means of a biometric sensor 730. In addition to the fingerprint scanner 730 and key socket 740, there is also an LED light 720 located on the outside of the lockable hinged panel 710.

To unlock the mailbox 700 via biometric means, the mailbox user places his/her finger on the fingerprint scanner 730. By placing a finger on the fingerprint scanner 730, the biometric enabled mailbox is activated, and the fingerprint scanning process begins. The mailbox user's fingerprint is scanned and passed to the verification logic 350. If the inputted biometric identifier is valid, then the LED 720 will display a green light to signify that the verification process has completed successfully. The lockable hinged panel 710 will automatically unlock via a powered locked 380 used by the mailbox 700. The lockable hinged panel 710 will swing open via the hinges 750 as shown in FIG. 7B. The mailbox user can now access the inside of the mailbox 700.

Once the lockable hinged panel 710 is opened, the mailbox 700 can be programmed. The biometric enabled mailbox system of this embodiment enters programming mode when the lockable hinged panel 710 is opened.

While in programming mode, the biometric enabled mailbox system allows for the addition of authorized biometric identifiers, removal of stored biometric identifiers, and resetting of all stored biometric identifiers.

To add a new biometric identifier to the biometric enabled mailbox system, the mailbox administrator presses the button labeled ADD 770. Once the ADD button 770 has been selected, the biometric enabled mailbox system is ready to receive a new biometric identifier. The biometric identifier to be added is received via the biometric sensor 730. After the biometric identifier is received and stored into the biometric enabled mailbox system's data storage 370, the LED 720 will display a green light to denote that the additional has completed successfully.

To remove a stored biometric identifier from the biometric enabled mailbox system, the mailbox administrator presses the button labeled REMOVE 780. After pressing the REMOVE button 780, the biometric enabled mailbox system expects to receive the biometric identifier of the biometric identifier to be removed from the system's data storage 370. The biometric identifier is received by the system via the biometric sensor 730. Once a biometric identifier is received by the system, the system will locate the matching biometric identifier in the data storage 370 and remove that biometric identifier. The LED 720 will then display a green light to signify that the removal has occurred successfully. However, if a matching biometric identifier cannot be found from the data storage 370, then no biometric identifier will be removed from the data storage 370 and the LED 720 will display a red light to signify a failure in the removal process.

To reset the biometric enabled mailbox system, the RESET button 790 simply needs to be pressed for at least ten seconds. Thereafter, the biometric enabled mailbox system will remove all biometric identifiers from the data storage 370. In addition, the LED 720 will display a green light to signify that the reset process has completed successfully.

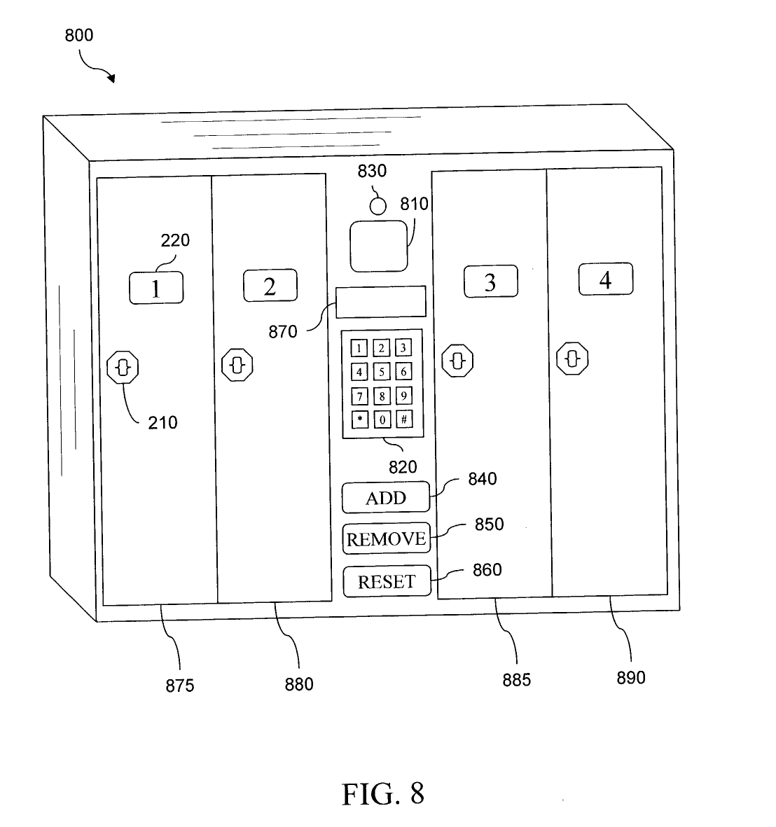

FIG. 8 is a front perspective view of a biometric enabled mailbox system in a multiple mailbox environment. More specifically, the biometric enabled mailbox system in FIG. 8 manages four mailboxes.

Each mailbox of the biometric enabled mailbox system of this embodiment can be unlocked via a conventional key and key socket 210, or by biometric means. The mailboxes 800 each contain a label 220 to distinguish the individual mailboxes 800. For example, the first mailbox 875 is labeled 1, the second mailbox 880 is labeled 2, the third 885 mailbox is labeled 3, and the fourth mailbox 890 is labeled 4. In between the second mailbox and the third mailbox, there are several components, including an LED 830, a biometric sensor 810, a display 870, a keypad 820, an ADD button 840, a REMOVE button 850, and a RESET button 860.

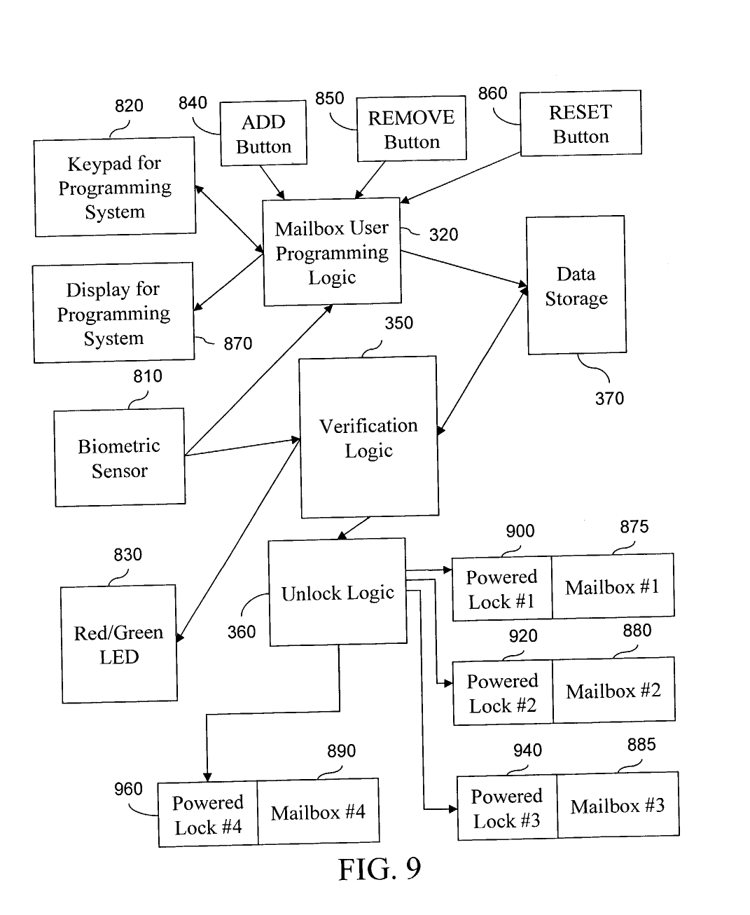

FIG. 9 shows a more detailed technical block diagram of the components from the mailbox 800 in FIG. 8.

In this embodiment, the mailbox 800 uses a fingerprint scanner 810 as its biometric sensor 810. A mailbox user of any of the four mailboxes 800 opens his/her mailbox by placing his/her finger on the fingerprint scanner 810. The biometric enabled mailbox system will automatically activate upon detecting the finger on the fingerprint scanner 810. The fingerprint will be scanned and passed on to the verification logic 350. The verification logic 350 will check to see if the inputted biometric identifier matches any authorized biometric identifiers in the data storage 370. If the verification logic 350 is unable to match the inputted biometric identifier with any authorized biometric identifiers stored in the data storage 370, the unlocking process will fail, and the LED 830 will display a red light. If the verification logic 350 is able to match the inputted biometric identifier with an authorized biometric identifier stored in the data storage 370, the verification logic 350 will then figure out which mailbox is the proper mailbox to unlock. An association between a particular mailbox and a biometric identifier is also stored within the data storage 370. The verification logic 350 figures out the proper mailbox to unlock by looking it up this association in the data storage 370. Once the proper mailbox has been located, a message is sent to the unlock logic 360. The message specifies which mailbox is the proper mailbox to unlock. The unlock logic 360, based on the message received, will send a power current to the powered lock associated with the proper mailbox. For example, if the verification logic 350 determines that the proper mailbox is mailbox #1, the verification logic 350 will send a message to the unlock logic 360 specifying that mailbox #1 is to be unlocked. The unlock logic 360 will then send a power current to powered lock #1 900 to unlock mailbox #1 875. In addition, the LED 830 will display a green light to signify to the mailbox user that the unlock process has completed successfully. Mailbox #1 875 is now unlocked, and the mailbox user can access his/her mail from within the mailbox 875.

The mailbox 800 can be placed into programming mode by entering a secret code on the keypad 820. Once in programming mode, a mailbox administrator will be able to add new biometric identifiers into the system for a particular mailbox, remove stored biometric identifiers from the system for a particular mailbox, or reset all stored biometric identifiers from the system for a particular mailbox. The programming display 870 will prompt the mailbox administrator to choose one of these three functions.

In order to add a new biometric identifier for a particular mailbox, the mailbox administrator first presses the button labeled ADD 840. The programming display 870 will ask which mailbox the new biometric identifier should be added for. The mailbox administrator uses the keypad 820 to specify the mailbox to be programmed. Next, the system is ready to receive the new biometric identifier to be added. The biometric sensor 810 is used to receive the new biometric identifier. Once received, the mailbox user programming logic 320 will store the new biometric identifier into the data storage 370. The association between the newly added biometric identifier and the proper mailbox is also stored in the data storage 370. Finally, the programming display 870 displays a success message to signify that the addition process has completed successfully.

To remove a stored biometric identifier for a particular mailbox, the mailbox administrator presses the button labeled REMOVE 850. The programming display 870 will ask the mailbox administrator to specify the mailbox to remove from. The mailbox administrator specifies the mailbox using the keypad 820. Next, the system needs to know which stored biometric identifier to remove. A biometric identifier to be removed needs to be received by the system via the biometric sensor 810. Once received, the mailbox user programming logic 320 will search the data storage 370 for an authorized biometric identifier which matches the inputted biometric identifier, for the mailbox specified. If found, the user programming logic 320 will remove the matching authorized biometric identifier from the data storage 370. The programming display 870 will display a success message to signify that the removal has completed successfully. If a match is not found, no biometric identifiers will be removed from the data storage 370, and the programming display 870 will display a message informing the mailbox administrator that there was no match found.

To reset all stored biometric identifiers for a particular mailbox, the mailbox administrator presses the button labeled RESET 860. Thereafter, the programming display 870 will ask the mailbox administrator to specify which mailbox needs to be reset. The mailbox administrator specifies the particular mailbox to be reset using the keypad 820. The mailbox user programming logic 320, upon receiving the information about which mailbox to reset will remove all stored biometric identifiers for that particular mailbox from the data storage 370. The programming display 870 will display a message to inform the mailbox administrator that the reset process has completed successfully.

Although the present invention has been described in detail with respect to certain embodiments and examples, variations and modifications exist which are within the scope of the present invention as defined in the following claims.

What is claimed is:

1. A secure mailbox system comprising:
a biometric sensor for inputting a biometric identifier;
a data storage for storing authorized biometric identifier;
a programming interface for adding and removing said authorized biometric identifier from said data storage;
a processor in communication with said data storage to perform validation that an inputted biometric identifier from said biometric sensor matches said authorized biometric identifier in said data storage; and
a powered lock for unlocking a mailbox of said secure mailbox system after said processor successfully performs said validation.

2. The system of claim 1, wherein said biometric sensor is a fingerprint scanner.

3. The system of claim 1, wherein said biometric sensor is a retinal scanner.

4. The system of claim 1, wherein said storage medium stores a log for the usage of said biometric sensor.

5. The system of claim 1, wherein said storage medium stores an association between said authorized biometric identifier and an associated mailbox.

6. The system of claim 5, wherein said mailbox to be unlocked is the associated mailbox.

7. The system of claim 1, wherein said powered lock is able to be unlocked with a key.

8. The system of claim 1, wherein said powered lock is an electromagnetic lock.

9. The system of claim 1, wherein said powered lock is an electric strike lock.

10. The system of claim 1, further comprising a key activated sensor for placing the system into programming mode.

11. The system of claim 1, wherein said programming interface is comprised of a keypad.

12. The system of claim 11, wherein said keypad is used for placing the system into programming mode.

13. A secure mailbox system comprising:
means for storing an authorized biometric identifier;
means for adding said authorized biometric identifier to said secure mailbox system for storage;
means for removing said authorized biometric identifier from said storage;
means for inputting a new biometric identifier into said secure mailbox system to unlock a mailbox of said secure mailbox system;
means for validating said new biometric identifier, said new biometric identifier is valid if said new biometric identifier matches said authorized biometric identifier from said storage; and
means for power unlocking said mailbox of said secure mailbox system.

14. A method for unlocking a mailbox of a biometric enabled mailbox system, comprising:
inputting an authorized biometric identifier to said mailbox system;
storing said authorized biometric identifier;
receiving a new biometric identifier by said mailbox system;
verifying that there is a match between said new biometric identifier and said authorized biometric identifier; and
unlocking said mailbox if said verifying step is successful.

15. The method as recited in claim 14, further including the step of storing an association between said authorized biometric identifier and an associated mailbox.

16. The method as recited in claim 15, wherein said mailbox to be unlocked is the associated mailbox.

17. The method as recited in claim 14, wherein said biometric identifier is a fingerprint.

18. The method as recited in claim 14, wherein the biometric identifier is a retinal scan.

19. The method as recited in claim 14, wherein said authorized biometric identifier stored is encrypted.

20. The method as recited in claim 14, further including the step of storing an activity log.
